(19) United States
(12) Patent Application Publication
(10) Pub. No.: US 2012/0009458 A1
(43) Pub. Date: Jan. 12, 2012

(54) Connecting structure for exteriorly connecting a battery cell and a load

(76) Inventor: Donald P.H. WU, Hsinchu County (TW)

(21) Appl. No.: 12/834,834

(22) Filed: Jul. 12, 2010

(51) Int. Cl. H01M 2/28

(52) U.S. Cl. 429/121

(57) ABSTRACT

A connecting structure for exteriorly connecting a battery cell and a load comprises a battery cell exteriorly provided with a positive electrode terminal and a negative electrode terminal which are made of nickel-plated metal, a first connecting graphite block, and a second connecting graphite block. The battery cell is connected to a load through the first and the second connecting graphite blocks that are connected to the positive and the negative electrode terminals of the battery cell, respectively. The graphite is inexpensive and resistant to oxidation; whereas, the connecting graphite blocks and the nickel-plated metal made electrode terminals of the battery cell will melt together to form a carbon-nickel alloy after being brought into contact with one another, thus ensuring a smooth large-current discharge because of the reduction in resistance of external connection.

### BACKGROUND OF THE INVENTION

1. Field of the Invention

The present invention relates to a non-welding and oxidation resistant connecting structure for exteriorly connecting a battery cell and a load at a high conductivity.

2. Description of the Prior Art

Referring to FIG. 1 showing a conventional connecting structure for exteriorly connecting a battery cell and a load, a battery cell 10 and a load 11 are connected in such a manner that a positive electrode terminal 12 and a negative electrode terminal 13 of the battery cell 10 each are brought into contact with a metal terminal 14 first, and then the metal terminals 14 will be connected to the load 11. Due to direct contact between the electrode terminals and the metal terminals, a high contact resistance will be caused at the respective contact portions of the electrode terminals and the metal terminals, so that when the battery cell is switched on, the contact portion will heat up and consume power of the battery cell. To reduce the contact resistance, referring to FIG. 2, the battery cell 10 is connected to nickel sheets 15 by spot welding, and then the nickel sheets 15 are connected to the load 11 to realize the connection between the battery cell and the load, greatly reducing the contact resistance while improving the non-oxidizability.

It is to be noted that, intense heat caused during the spot welding will be conducted to into the battery cell to cause damages to interior of the battery cell, such as: breakage of the seal gasket, and rupture of the isolating layers, and etc, thus leading to failure of the battery. In addition, the cost of the welding procedure is relatively high.

Hence, it can be found that the conventional connection between a battery cell and a load cannot satisfy the basic requirements of the cost economics, high conductivity and high relativity. However, it will be a breakthrough to the existing battery-connection technique if the connection conductivity can be improved without the use of welding.

Hereafter, the present invention has arisen to mitigate and/or obviate the afore-described disadvantages.

### SUMMARY OF THE INVENTION

The primary objective of the present invention is to provide a connecting structure for exteriorly a battery cell and a load in accordance with the present invention mainly utilizes a first connecting graphite block and a second connecting graphite block that are respectively connected to a positive electrode terminal and a negative electrode terminal of a battery cell in a close contact manner to connect the battery cell and a load. In the present invention, the connecting graphite blocks are connected to the electrode terminals of the battery cell in a direct contact manner to realize a highly conductive connection without the use of the welding. Furthermore, the graphite is less-expensive compared to nickel so that the production cost can be greatly reduced.

The secondary objective of the present invention is to provide a connecting structure for exteriorly connecting a battery cell and a load which mainly utilizes a first connecting graphite block and a second connecting graphite block that are respectively connected to a positive electrode terminal and a negative electrode terminal of a battery cell in a close contact manner to connect the battery cell and a load. After being brought into contact with one another, the connecting graphite blocks and the positive, the negative electrode terminals of the battery cell will start a process of melting together, that is, carbon particles of the connecting graphite blocks will substitute for the foreign matters on the negative and the positive electrode terminals of the battery cell and fill the voids of the negative and the positive electrode terminals of the battery cell, forming a carbon-nickel alloy, thus ensuring a smooth large-current discharge due to reduction of the external connection resistance.

In order to achieve the above objectives, a connecting structure for exteriorly connecting a battery cell and a load in accordance with the present invention comprises: a battery cell, a first connecting graphite block, and a second connecting graphite block.

The battery cell is exteriorly provided with a positive electrode terminal and a negative electrode terminal which are made of nickel-plated metal and served as power output terminals of the battery cell;

The first connecting graphite block is connected to the positive electrode terminal of the battery cell and a load; and

The second connecting graphite block is connected to the negative electrode terminal of the battery cell and the load.

By such arrangements, the battery cell can be connected to the load through the first and the second connecting graphite blocks.

### BRIEF DESCRIPTION OF THE DRAWINGS

FIG. 1 is a schematic view of a conventional connecting structure for exteriorly connecting a battery cell and a load which utilizes metal terminals to connect the battery cell and the load;

FIG. 2 is a schematic view of a conventional connecting structure for exteriorly connecting a battery cell and a load which utilizes nickel sheets to connect the battery cell and the load;

FIG. 3 is a schematic view of a connecting structure for exteriorly connecting a battery cell and a load in accordance with the present invention utilizes two connecting graphite blocks to connect the battery cell and the load;

FIG. 4A shows the respective electrode terminals of the battery cell being covered with foreign matters in accordance with the present invention;

FIG. 4 B shows carbon particles substituting for the foreign matters after the first and the second connecting graphite blocks are brought into contact with the electrode terminals in accordance with present invention; and

FIG. 5 is a schematic view showing that the connecting structure for exteriorly connecting a battery cell and a load in accordance with the present invention utilizes two connecting graphite blocks to connect a coffee-bagged battery cell packaged in an aluminum bag to the load.

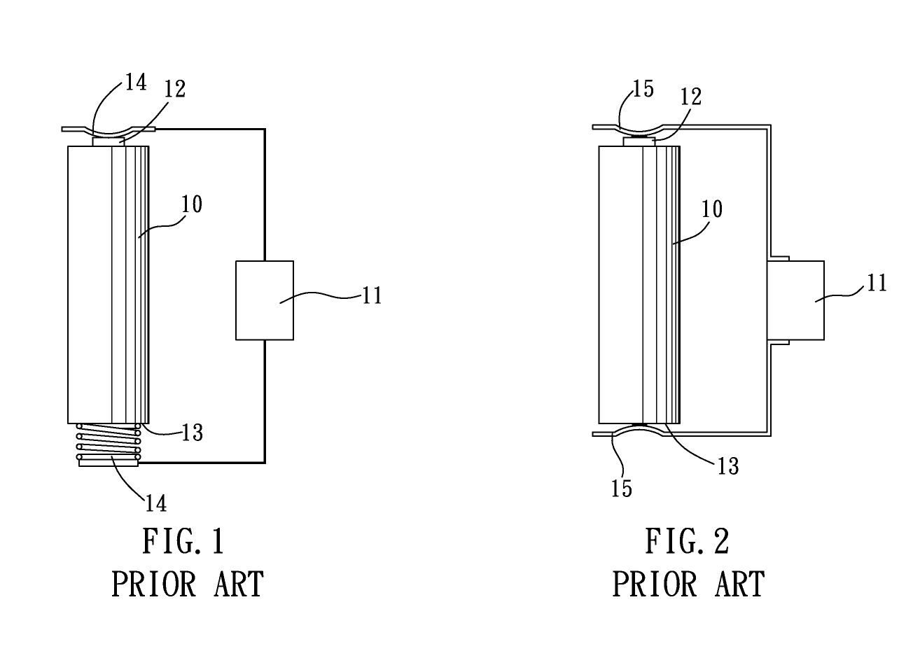

### DETAILED DESCRIPTION OF THE PREFERRED EMBODIMENTS

The present invention will be easily comprehended from the following description when viewed together with the accompanying drawings, which show, for purpose of illustrations only, the preferred embodiment in accordance with the present invention.

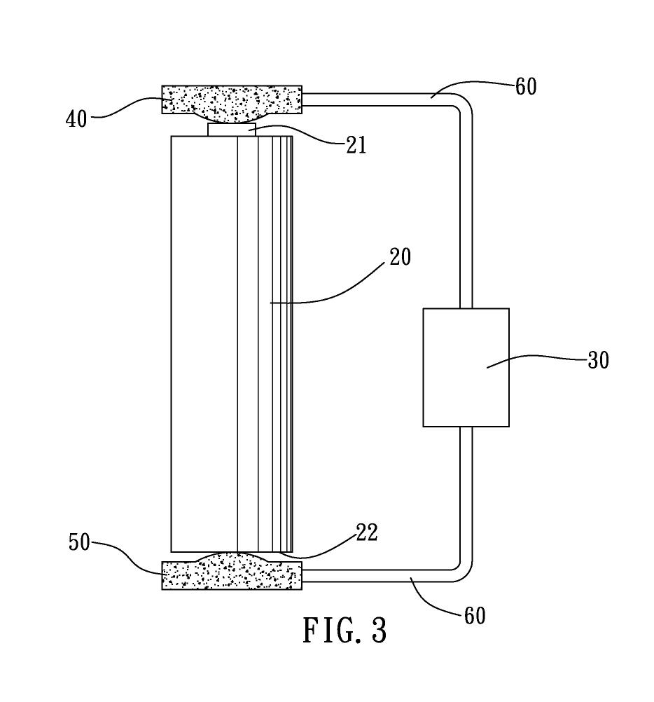

Referring to FIG. 3, when a battery cell 20 and a load 30 are electrically connected, a first connecting graphite block 40 and a second connecting graphite block 50 will be electrically connected to a positive electrode terminal 21 and a negative electrode terminal 22 of the battery cell 20 first, and then will be connected to the load 30, thus improving the electric conductivity between the battery cell 20 and the load 30.

The battery cell 20 is a cylindrical battery cell and exteriorly provided on both ends thereof with the positive electrode terminal 21 and the negative electrode terminal 22 which are made of nickel-plated metal and served as power output terminals of the battery cell 20.

The first connecting graphite block 40 is made of a material selected from the group consisting of pure graphite, graphite alloy and conductive carbon. The graphite alloy can be a silver graphite (silver-carbon alloy), a copper graphite (copper-carbon alloy), and etc. The first connecting graphite block 40 is electrically connected to the positive electrode terminal 21 of the first battery cell 20 in a close contact manner.

The second connecting graphite block 50 is made of a material selected from the group consisting of pure graphite, graphite alloy and conductive carbon. The second connecting graphite block 50 is electrically connected to the positive electrode terminal 21 of the first battery cell 20 in a close contact manner. The battery cell 20 and the load 30 are then electrically connected through the first and the second connecting graphite blocks 40, 50.

The first and the second connecting graphite blocks 40, 50 each are interiorly provided with a wire 60 serving as a power output wire of the battery cell 20, so that the first and the second connecting graphite blocks 40, 50 can be connected to the load 30 through the wires 60.

The aforementioned is the summary of the positional and structural relationship of the respective components of the preferred embodiment in accordance with the present invention.

For a better understanding of the present invention, its operation and function, reference should be made to the following description:

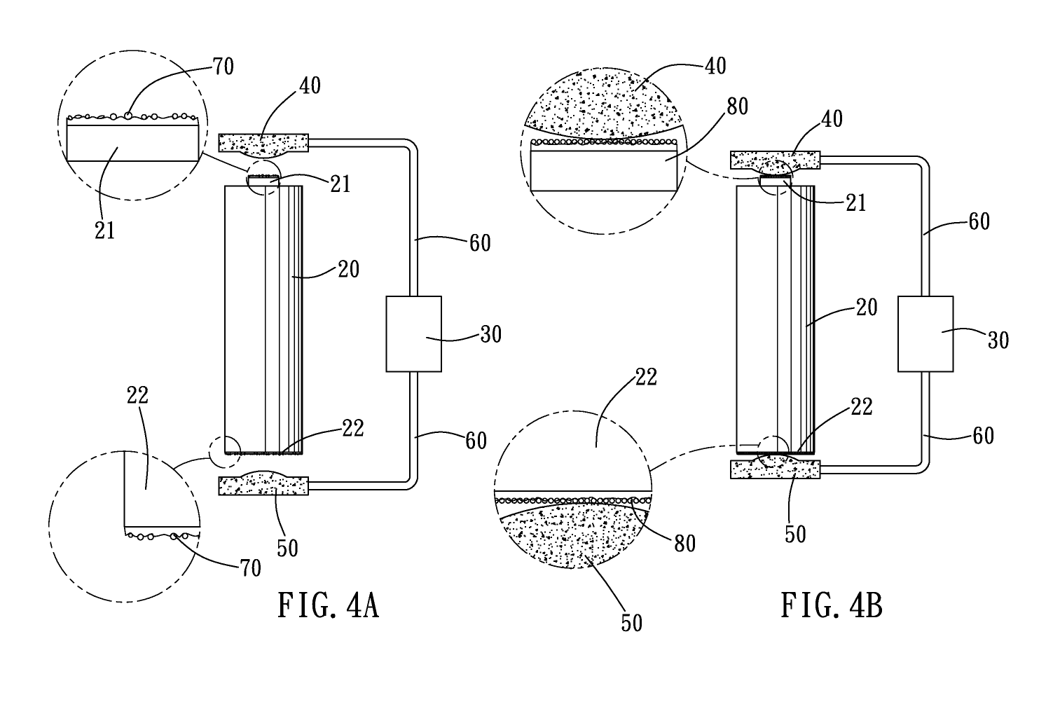

The positive and the negative electrode terminals 21, 22 of the battery cell 20 are both made of the nickel-plated metal, as shown in FIG. 4A, the positive and the negative electrode terminals 21, 22 each might be covered with foreign matters 70 or oxides, which will increase the connection resistance during the discharging process of the battery cell 20 while reducing the discharging power efficiency of the battery cell 20. Referring to FIG. 4B showing how to realize high conductivity connection between the battery cell and the load, the first and the second connecting graphite blocks 40, 50 are resistant to oxidation and electrically connected to the positive and the negative electrode terminals 21, 22 of the battery cell 20. The first and second connecting graphite blocks 40, 50 and the positive and negative electrode terminals 21, 22 of the battery cell 20 will melt together after being brought into contact with one another, that is, the carbon particles 80 of the first and the second connecting graphite blocks 40, 50 will substitute for the foreign matters 70 or oxides on the positive and negative electrode terminals 21, 22 made of nickel-plated metal so as to fill in the voids in the positive and the negative electrode terminals 21, 22 of the battery cell 20, forming a carbon-nickel alloy, which improves the connection conductivity between the first, the second connecting graphite blocks 40, 50 and the battery cell 20. In other words, after the battery cell 20 in accordance with the present invention is switched on, electric current will circulate through the battery cell 20, the first connecting graphite block 40 and the second connecting graphite block 50 smoothly without being affected by the inherent resistance caused by the oxides or the foreign matters 70, thus not only reducing the external connection resistance between the battery cell 20 and the load 30, but facilitating the successful discharging of the battery cell 20.

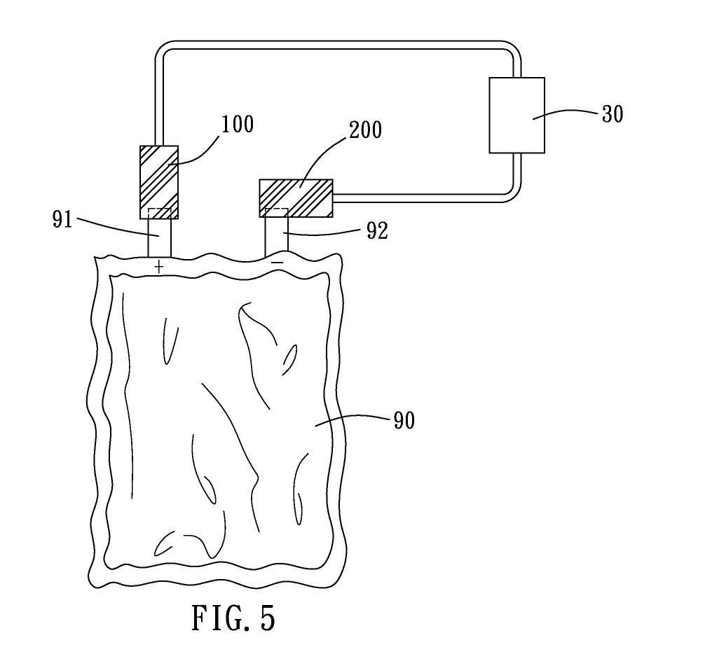

In addition to the cylindrical battery cell with metal jacket, as shown in FIG. 5, the present invention is also applicable to a coffee-bagged battery cell 90 which is packaged in an aluminum bag. The positive and the negative electrodes of the coffee-bagged battery cell 90 are normally stamp-formed into a positive electrode tab 91 and a negative electrode tab 92 that are both made of nickel-plated metal. When the coffee-bagged battery cell 90 is connected to the load 30, a third connecting graphite block 100 and a fourth connecting graphite block 200 will be electrically connected to the positive and the negative electrode tabs 91, 92 of the coffee-bagged battery cell 90, respectively. It is to be noted that, the battery cell with metal jacket and the coffee-bagged battery cell, although having different shapes, are the same in terms of electrical connection effects. In other words, the technology of the present invention is independent to the internal configuration of the battery cell as long as the positive and the negative electrode terminals of the battery cell are made of the nickel-plated metal, hence, the battery cell and the load can be connected through the connecting graphite blocks of the present invention to realize the high conductivity external connection therebetween.

While we have shown and described various embodiments in accordance with the present invention, it is comprehensive to those skilled in the art that further embodiments may be made without departing from the scope of the present invention.

What is claimed is:

1. A connecting structure for exteriorly connecting a battery cell and a load comprising:
a battery cell being exteriorly provided with a positive electrode terminal and a negative electrode terminal which are made of nickel-plated metal and served as power output terminals of the battery cell;
a first connecting graphite block connected to the positive electrode terminal of the battery cell and a load; and
a second connecting graphite block connected to the negative electrode terminal of the battery cell and the load; by such arrangements, the battery cell is electrically connected to the load by the first and second connecting graphite blocks.

2. The connecting structure for exteriorly connecting a battery cell and a load as claimed in claim 1, wherein the first and the second connecting graphite blocks are made of pure graphite.

3. The connecting structure for exteriorly connecting a battery cell and a load as claimed in claim 1, wherein the first and the second connecting graphite blocks are made of graphite alloy.

4. The connecting structure for exteriorly connecting a battery cell and a load as claimed in claim 3, wherein the graphite alloy is a silver-carbon alloy.

5. The connecting structure for exteriorly connecting a battery cell and a load as claimed in claim 3, wherein the graphite alloy is a copper-carbon alloy.

6. The connecting structure for exteriorly connecting a battery cell and a load as claimed in claim 1, wherein the first and the second connecting graphite blocks each are interiorly provided with a wire serving as a power output wire of the battery cell.
